(19) United States
(12) Patent Application Publication
(10) Pub. No.: US 2026/0142835 A1
(43) Pub. Date: May 21, 2026

(54) Technique for Signature Generation Using a Digital Key In a Terminal

(71) Applicant: Bayerische Motoren Werke Aktiengesellschaft, Muenchen (DE)

(72) Inventors: Matthias FINK, Muenchen (DE); Peter WINKLHOFER, Muenchen (DE)

(21) Appl. No.: 19/381,314

(22) Filed: Nov. 6, 2025

(30) Foreign Application Priority Data
Nov. 20, 2024 (DE) 10 2024 134 130.0

(51) Int. Cl. H04L 9/32; H04L 9/08

(52) U.S. Cl. CPC H04L 9/3247; H04L 9/0825; H04L 9/0894

(57) ABSTRACT

A method for controlling signature generation in a terminal includes receiving signed process data and verifying the received signed process data; outputting user information based on the verified process data on a user interface of the terminal; accepting a user input; signing signature data based on the verified process data using a digital signature key; and transmitting the signed signature data. The method is used by an operating system of the terminal to encapsulate a display to the user, their confirmation, and a subsequently generated signature for the process in a secure function. This allows safety of a user confirmation for a given process to be raised from a level of an application to a level of the operating system.

### CROSS REFERENCE TO RELATED APPLICATION

This application claims priority under 35 U.S.C. § 119 from German Patent Application No. DE 10 2024 134 130.0, filed Nov. 20, 2024, the entire disclosure of which is herein expressly incorporated by reference.

### BACKGROUND AND SUMMARY

The present disclosure relates to a technique for signature generation. In particular, the present disclosure relates to a technique for generating a signature using a digital signature key in a terminal.

It is known that a terminal, for example a smartphone, may store a digital key (e.g. for a vehicle), for instance in a secure memory of the device. Use of the key is based on interfaces between the secure memory and an operating system of the device, and on interfaces between the operating system and other applications that are executed on the device.

As such, the Car Connectivity Consortium (CCC) uses Digital Key Release 3 in the form of a technical specification to define a standard for a digital vehicle key. Corresponding digital keys are therefore being used increasingly in an expanded vehicle setting.

As such, a terminal may for instance have an application, or app, of a vehicle manufacturer installed on it that uses the digital vehicle key stored on the device to permit access to the vehicle, permits control of specific vehicle functions, etc. Expanded opportunities for use additionally result from the existence of a backend system for managing the digital vehicle key.

Methods for digital key generation are used to check the authenticity of digital messages, documents, data, etc. As such, a valid digital signature for a message provides a receiver with the certainty that the message comes from a sender known to the receiver. A digital signature can therefore be used for example for performing and guaranteeing a data transfer, electronic transactions, in general for administrative purposes, management, etc.

A digital signature can be based on a cryptographic method, e.g. a digital signature can use asymmetric cryptography. A digital signature key is thus intended to be understood to mean an (electronic) cryptographic component that can be used in (electronic) signature processes to check and therefore be sure of, or guarantee, an identity of a signatory and/or integrity of a document.

Generally, besides signature keys provided specifically for this purpose, other digital keys can also be used for signature generation. By way of example, a digital vehicle key mentioned above can also be used to sign arbitrary data (an “arbitrary data” concept is defined by the CCC). CCC Release 4 will additionally allow vehicle-related rights for sharing a digital vehicle key (key sharing) to be delegated to a backend, and within this context too it is conceivable for the digital vehicle key to be used for signing.

A method for signature generation can consist of two parts: first, information about the signature generation is submitted, for example indicating what is supposed to be signed; the actual generation of the signature is then performed for specific data. Given a basic situation such as this, an attack vector can result from a discrepancy between the information that is indicated or displayed and the data that are actually signed. Consequently, a backend can assume that the user has approved a specific process, for example the performance of a specific action or operation; in actual fact, however, the user has agreed not to this action but rather to another action.

One object on which the present disclosure is based is to provide an improved concept for a technique for controlling signature generation using a digital key. The present disclosure achieves this object by the subjects of the independent claims. Dependent claims provide preferred embodiments.

A first aspect of the present disclosure relates to a method for controlling signature generation in a terminal. The method may be implemented in an operating system of the terminal. The method comprises receiving signed process data and verifying the received signed process data on the basis of a trust anchor. The trust anchor is stored in a secure memory of the terminal. The method also comprises outputting user information based on the verified process data on a user interface of the terminal. The method also comprises accepting a user input, for example via the user interface. The method also comprises, on the basis of the user input, signing signature data based on the verified process data using a digital signature key. The digital signature key is stored in the secure memory of the terminal. The method lastly comprises transmitting the signed signature data.

A terminal is intended to be understood herein to mean any device that represents an endpoint of electronic communication, of a communication network, etc., and is configured for use, operation, etc., by a human user, a person, an operator, etc. A terminal may be, for example, a mobile device, a portable device, a wearable, that is to say for instance a notebook, tablet or smartphone, a smartwatch, a smart band, a smart ring, etc. Devices for stationary use such as a PC, an operator console, etc., are also terminals. This is also supposed to encompass situations in which a terminal is used with other peripheral components, that is to say for example a mobile device is used with a smart card, or any other situation or any other, including future, device that has the requisite processor capacities, storage capacities, etc.

The terminal can have a secure memory, or a secure environment, a secure element, etc., for example based on an appropriate chip, a cryptoprocessor, etc. By way of example, the secure memory can be an HSM (Hardware Security Module), a TPM (Trusted Platform Module), a secure element (Secure Enclave), a TEE (Trusted Execution Environment), etc.

A terminal can have multiple secure memories, corresponding storage elements, etc. By way of example, a trust anchor may be stored in a first secure memory and a signature key may be stored in a second secure memory of one and the same device. Although “a” secure memory is referred to herein, situations with more than one secure memory are always supposed to be covered as well.

A secure memory may be configured to save, or store, at least one cryptographic, electronic or digital key. By way of example, a secure memory may be configured to store a trust anchor and a cryptographic or digital signature key.

The terminal can exhibit a PKI (Public Key Infrastructure), a root element, a CA (Certificate Authority), etc., for outputting cryptographic or digital certificates. The secure memory may be configured to store at least one digital certificate, or may be configured to store multiple digital certificates, for example an authority CA certificate, an intermediate certificate, etc.

In preferred embodiments, the trust anchor can relate to a directly exchanged or pinned (cf. trust-on-first-use) or cross-signed certificate (cross-certificate) that applies to a backend key in a process-related backend at least by a chain of trust. By way of example, a pinned or cross-signed certificate (e.g. of a device-based CA authority cross-signed by a vehicle manufacturer) can be available in a device-based backend.

In various embodiments, the digital signature key for the requested process can comprise for example a key specified by the CCC, that is to say for example a digital vehicle key for accessing a motor vehicle; by way of example, an appropriate endpoint may be stored in the secure memory. In other embodiments, the signature key can comprise a cryptographic key of a CA authority of the terminal that resides in a hierarchy between root and leaf on an intermediate CA level between an endpoint for a digital vehicle key and a CA level of a device-based backend.

In other embodiments again, the digital signature key used for signature generation can also comprise a cryptographic key that is not specified by the CCC. By way of example, the signature key can comprise a cryptographic signature key that is provided by the secure memory itself, that is to say for example a zone signature key of a secure zone, a secure zone key of an iOS Secure Enclave, an Android TEE, etc.

In yet other embodiments, the signature key can comprise a cryptographic key that is provided or supported by the operating system.

The operating system of the terminal can be for example an inherently known operating system for mobile devices, that is to say for instance iOS or Android, but it can also be an operating system for a PC or a computer in a commercial or industrial setting, that is to say for instance an operating system as is known for an area of an industrial automation.

In some embodiments, the operating system of the terminal controls the verification of the received process data, the output of the user information, the acceptance of the user input, and/or the signing of the signature data, etc. End-to-end control by the operating system can prevent a compromised app from feigning signature generation for another process that differs from the process for which the signature generation actually takes place.

A process, use case, etc., requested by a user, or an action, operation, etc., can relate to a unilateral data transfer, a bilateral message exchange, etc. A process may be standardized, for example by a panel such as the CCC, which develops applicable technical specifications. In an embodiment of a method according to the first aspect of the present disclosure, the process data can be received in a standardized format, for example. The process data can be any data, parameters, information, etc., suitable for describing the requested process, characterizing it (for example in parameterized form), tagging it, entitling it, restricting it to specific process types or modes, etc.

The user interface of the terminal can in general be an HMI (Human Machine Interface) that can be used for example to provide an optical or visual output (and/or input) on a display or the like, but which can additionally or alternatively also produce audible outputs (and/or can accept inputs), inputs or outputs using haptics or gestures, etc. A user input in response to the user information can be provided by a user operation on the HMI, for example by soft or hard buttons, an audible input using voice commands, or else using gestures, etc.

In some embodiments, generating user information to be output can comprise taking, extracting or deriving the user information from the received process data. Additionally or alternatively, it is conceivable for some or all of the user information to be requested on the basis of the received process data, for example from a device-based backend that, for instance, can provide operating-system-specific information, information about actuating the user interface, etc. Additionally or alternatively, user information for a standardized process may be predefined and retrievable for example from a database. Such a database, table, etc., can be available on the terminal or in a backend.

Some embodiments of the first aspect of the present disclosure also comprise receiving an indication of a user authentication mode; and controlling the terminal to accept the user input according to the indication. The indication can provide, for example for a standardized process, a specific type of user intervention for consent, approval (or rejection), etc. It is also conceivable for the terminal to be provided with a list, for example a whitelist and/or blacklist, and for the terminal to be prepared or configured to accept the user input accordingly, the configuration also being able to be configuration-dependent, being able to be dependent on equipment on the terminal, etc. By way of example, there may merely be a requirement for consent from the user (e.g. a Yes/No input, or confirmation). Additionally or alternatively, an explicit user authentication can be required. By way of example, it can be a requirement for the authentication performed to be the same as when unlocking the device. In another example, there is the possibility, depending on the configuration, of permitting face recognition to be performed (face ID) or a fingerprint sensor to be used. Additionally or alternatively, input of a device PIN (Personal Identification Number) can be required, a two-factor or multi-factor authentication (2FA or MFA) can be required, etc.

A second aspect of the present disclosure relates to a method for controlling signature generation in an application for a terminal. The method may be implemented in an application, as may be provided for example by a vehicle manufacturer for key management of a digital vehicle key on the terminal. The method comprises receiving signed process data from a process-related backend; forwarding the signed process data to an operating system of the terminal to control a user input concerning the signature generation; accepting signed signature data from the operating system; and forwarding the signed signature data to the backend.

Some embodiments of the second aspect of the present disclosure also comprise receiving an upstream user input and transmitting a request to perform a (for example standardized) process on the basis of the upstream user input; and receiving a downstream acknowledgement relating to performance of the requested process.

A third aspect of the present disclosure relates to a method for controlling signature generation in a process-related backend, that is to say for instance a vehicle-related backend (e.g. operated by a vehicle manufacturer), at the premises of a service provider, etc. The method comprises receiving a request to perform a (for example standardized) process from a terminal; compiling process data concerning the requested process; signing the compiled process data using a backend key managed by the backend; and transmitting the signed process data to the terminal.

Some embodiments of the third aspect of the present disclosure also comprise receiving signed signature data relating to the requested process from the terminal; verifying the signature data on the basis of a digital signature key; and transmitting an acknowledgement relating to performance of the requested process to the terminal.

Another aspect of the present disclosure relates to a computer program product comprising program code sections for carrying out a method according to the first aspect of the present disclosure when the computer program product is executed on a computer. The computer program product can in particular relate to an operating system of a terminal.

Yet another aspect of the present disclosure relates to a computer program product comprising program code sections for carrying out a method according to the second aspect of the present disclosure when the computer program product is executed on a computer. The computer program product can in particular relate to an application, or app, for a terminal.

Another aspect of the present disclosure again relates to a terminal configured to carry out a corresponding method, described herein, for controlling signature generation. The terminal comprises a secure memory for storing a digital signature key, a trust anchor, etc. The terminal also comprises an operating system as described herein and an application as described herein.

Another aspect of the present disclosure relates to a backend server configured to carry out a corresponding method, described herein, for controlling signature generation.

Another aspect of the present disclosure again relates to a system configured to perform a process in a manner guaranteed by signature generation. The system can comprise an application described herein and a backend server described herein, or can comprise a terminal described herein and a backend server described herein.

The present disclosure will now be described in more detail with reference to the accompanying drawings, in which:

Other objects, advantages and novel features of the present disclosure will become apparent from the following detailed description of one or more preferred embodiments when considered in conjunction with the accompanying drawings.

### BRIEF DESCRIPTION OF THE DRAWINGS

FIG. 1A illustrates an overview of a system according to the present disclosure;

FIG. 1B illustrates further details of the system from FIG. 1A;

FIG. 2A illustrates a detailed flow diagram for a first method in the system from FIG. 1B;

FIG. 2B illustrates a detailed flow diagram for a second method in the system from FIG. 1B;

FIG. 2C illustrates a detailed flow diagram for a third method in the system from FIG. 1B;

FIG. 3 illustrates a flow diagram for a fourth embodiment of a method according to the present disclosure; and

FIG. 4 illustrates a flow diagram for a fifth embodiment of a method according to the present disclosure.

### DETAILED DESCRIPTION OF THE DRAWINGS

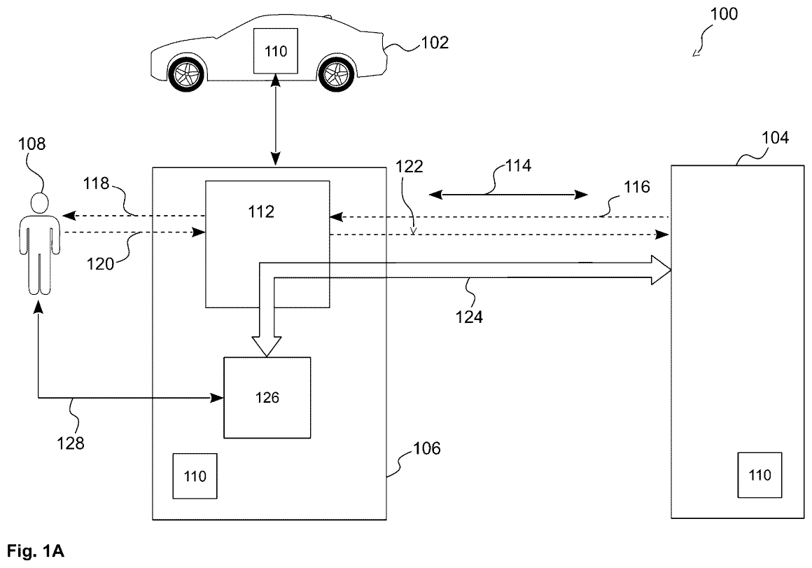

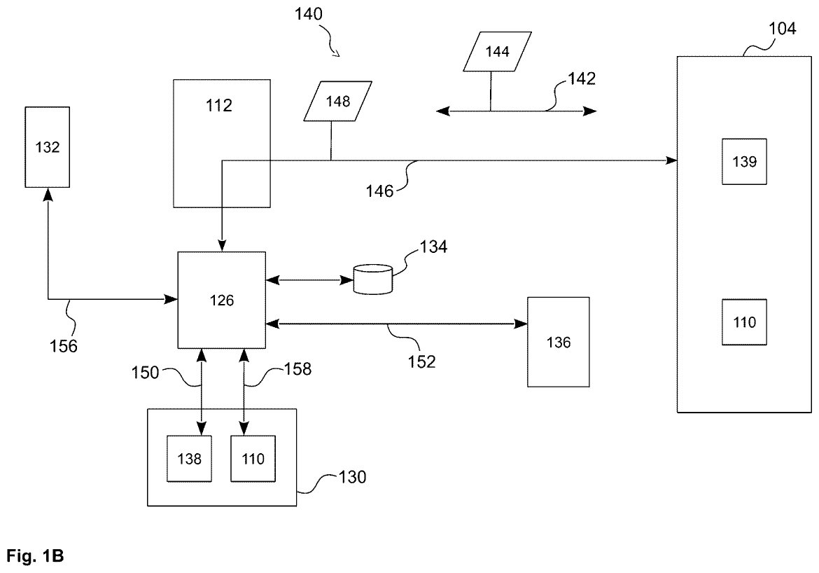

FIG. 1A shows, in schematic form, an embodiment of a system 100 according to the present disclosure, comprising a motor vehicle 102, a backend 104, a terminal 106 and a user 108. In an illustrative scenario, the user 108 is a driver or owner of the vehicle 102, and the user 108 uses the terminal 106, which may be a smartphone of the user 108, for example, to gain access to the vehicle 102 by a digital vehicle key 110. The digital vehicle key 110 may be stored in an appropriate form, as familiar to a person skilled in the art, in the vehicle 102, in the terminal 106 and in the backend 104. The backend 104 can be a vehicle-based or -related backend operated by a manufacturer of the vehicle 102, for example. The backend 104 can also be operated by a service provider, for instance a car sharing provider; in this case, the backend 104 comprises an SBFD server, which manages vehicle-related keys (SBFD=Server-Based Friend Device according to the CCC). The scenario described is intended to be understood by way of illustration; a multiplicity of other scenarios are conceivable and described herein.

Specifically, an application or app 112 for an interaction 114 with the vehicle 102 and/or the backend 104 is installed on the terminal 106. The interaction, or the process or use case, 114 can relate to a service activation by a service management request, as is or has been specified or standardized by the CCC and in the course of which the user 108 grants the backend 104 a right to share, forward, etc., the vehicle key 110 (SBFD scenario). The service management request can relate not only to an activation of a service but also to a change in a service, for example a deactivation.

Successful completion of the interaction (here: the service activation) 114 requires the user to explicitly approve the transfer of rights. For this, there can be provision for the backend 104 to transmit to the application 112 a message 116 containing user information (or the app has this user information available locally), and the app 112 produces an appropriate output 118 of the user information to the user 108. The user 108 reacts to the information with an input 120, for example by touching an OK button. The app 112 then transmits an acknowledgement 122 of a user consent (or rejection) to the backend 104.

The above illustration relates to a desirable mode of operation of the app 112. If the app 112 is compromised, however, it is conceivable for the app 112 to output to the user, with the user output 118, information that does not correspond to the user information which was transferred with the message 116 and which the user 108 has approved. By way of example, the user output 118 could require the user 108 to approve a non-essential process that does not relate to a transfer of rights.

The security problem, or problem of lack of reliability of the transfer of rights for a service activation, described above, is also not overcome as a result of the message 116 between the backend 104 and the app 112 being signed for verification purposes by the backend 104, since a compromised app 112 can dispense with a verification and use the user information that the message 116 contains just for the acknowledgement 122 to the backend 104, while different information is displayed to the user 108 with the user output 118.

The present disclosure instead proposes a procedure with a message exchange or a message sequence 124 that involves not only the backend 104 and the app 112 but also an operating system 126 of the terminal 106. It is assumed that the operating system 126 is not compromised and therefore a user output 128 and a transmission of the appropriate user acknowledgement in the sequence 124 are performed reliably. In this case, signature generation for the sequence 124 (in both directions) makes sure that even if the app 112 is corrupt the user confirms the desired process 114, or an action related thereto, and not some other action. The backend 104 can thus be confident that the user 108 has confirmed the action that is actually performed. Embodiments of the signature generation according to the present disclosure are described in more detail below.

FIG. 1B shows a detail from the system 100 of FIG. 1A, specifically in particular the backend 104 and also the app 112 and the operating system 126. FIG. 1B indicates other components of the terminal 106, namely a secure memory 130, an HMI 132 and a database or LUT (Look-Up Table) 134. Furthermore, a device-based backend 136 for the terminal 106 is indicated.

The secure memory 130 contains the digital vehicle key 110 for the vehicle 102, which is also used as a digital signature key in the embodiment outlined here. Other examples of a cryptographic key that can be used exclusively or also as a digital signature key are described herein. The secure memory 130 also contains a trust anchor 138 that applies to a cryptographic or digital backend key 139. The relationship between the trust anchor 138 and the backend key 139 can encompass the availability of a certificate or multiple certificates in the backend 104 and/or the backend 136, can encompass pinning or cross-signing, etc. A person skilled in the art is familiar with technical details in this regard.

According to the present disclosure, signature generation is controlled to make sure that reliable information is output on the HMI 132, and that a reliable indication relating to a subsequently performed user intervention (approval or rejection, authentication, etc.) reaches the backend 104. An overview of an operating cycle of a method 140 according to the present disclosure is illustrated in FIG. 1B on the basis of message pairs or (sub-)sequences that are exchanged between the components shown.

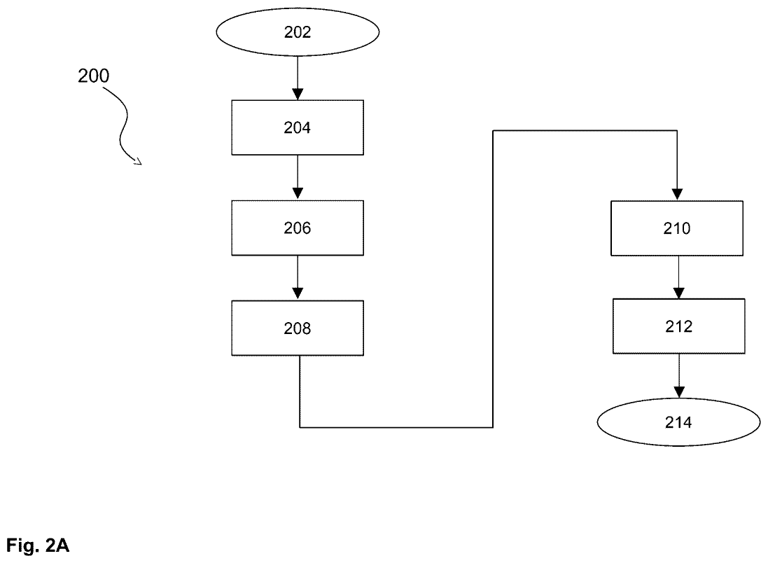

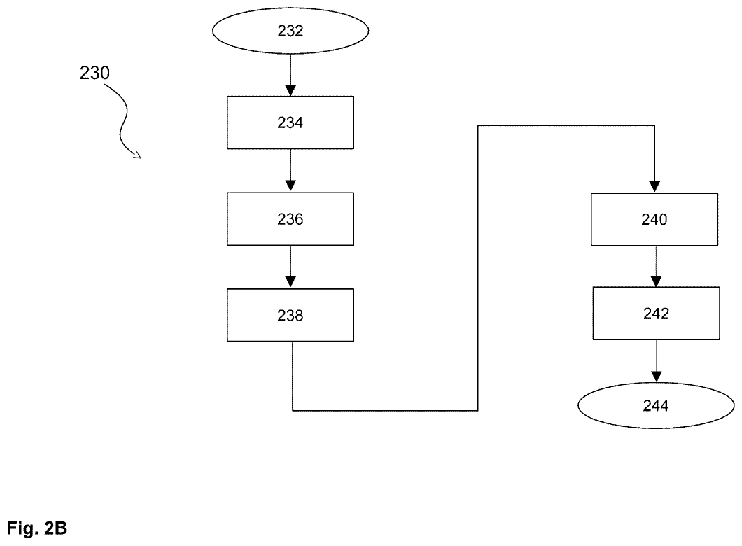

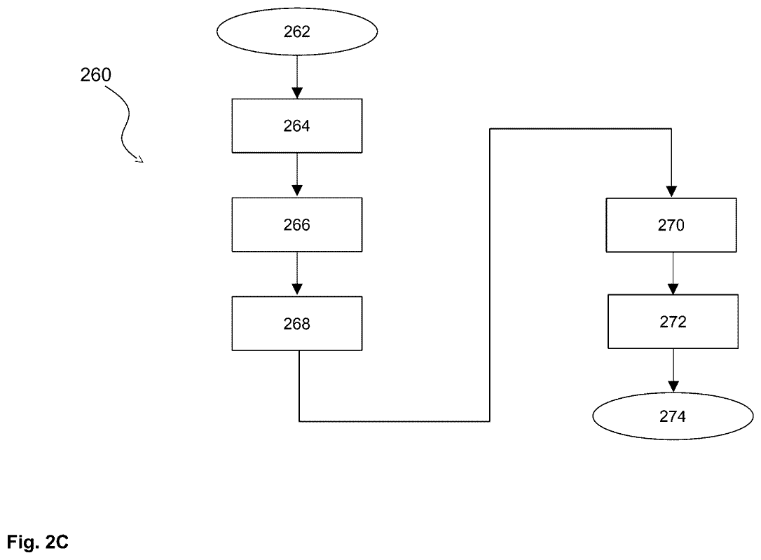

In addition, the cooperation of the operating system 126, the app 112 and the backend 104 for signature generation is described with reference to the operating cycles shown in FIGS. 2A, 2B and 2C, each time from the point of view of one of the components. In this case, FIG. 2A shows an operating cycle of a method 200 for controlling the signature generation in the operating system 124 of the terminal 106. FIG. 2B shows an operating cycle of a corresponding method 230 in the app 112. FIG. 2C shows an operating cycle of a corresponding method 260 in the backend 104. In other words, each of the methods 200, 230, 260 conveys the method 140 from the point of view of the relevant component.

The operating cycle 140 begins with a step 232 in the method 230 in FIG. 2B by virtue of an upstream user input being received in the app 112, the user input being able to relate for example to a service activation request (as specified by the CCC). In a step 234, the app 112 transmits a corresponding request to perform a corresponding (standardized) process to the process-related backend 104. This request initiates the message exchange or the sub-sequence 142 (FIG. 1B) relating to the requested process between the app 112 and the backend 104.

Correspondingly, in a step 262 (in the method 260 in FIG. 2C), the request to perform the process is received in the backend 104 from the terminal 106, or the app 112. In a step 264, the backend 104 compiles process data concerning the requested process 144. In a step 266, the backend 104 signs the compiled process data using the digital backend key 139. In a step 268, the backend 104 transmits the signed process data 148 to the terminal 106, or the app 112. This is the first message of a reliable sub-sequence 146 between the backend 104 and the operating system 126. The signed process data 148 can be sent in a standardized format, for example as specified by the CCC.

In a corresponding step 236 (method 230 in FIG. 2B), the app 112 receives the signed process data 148 from the backend 104. In a step 238, the app 112 forwards the signed process data 148 to the operating system 126 to control a user input concerning the signature generation.

In a corresponding step 202 (method 200 in FIG. 2A), the operating system 126 receives the signed process data 148 by way of the sub-sequence 150. In a step 204, the operating system 126 verifies the received signed process data by the trust anchor 138 held in the secure memory 130. The corresponding access by the operating system 136 to the trust anchor 138 in the secure memory 130 of the terminal 106 is indicated by a sub-sequence 150 in FIG. 1B. The verification of the signature can also encompass access or a message exchange 152 with the device-based backend 136, for example relating to a chain of trust for the backend key 139.

In a step 206, the operating system 126 generates user information. In one embodiment, the or some of the user information is extracted from the received process data 148. Additionally or alternatively, user information can be requested from the device-based backend 136 on the basis of the process data 148, and/or a standardized process, for instance a service activation according to the CCC, can be determined on the basis of the process data 148 and corresponding predefined user information can be determined or read, for example from the LUT 134.

In a step 208, the operating system 126 outputs the determined user information on the HMI 132; this is indicated as a sub-sequence 156 in FIG. 1B. In a step 210, the operating system 126 accepts a user input from the HMI 132, and this completes the sub-sequence 156. There is no sub-sequence between the app 112 and the HMI 132, i.e. the app 112 is not involved in obtaining a user consent, user authentication, etc.

In some embodiments, step 202 comprises not only receiving signed process data but also receiving an indication of a specific user authentication mode. In addition, step 210 comprises controlling the terminal to accept the user input according to the indication. By way of example, the backend 104 can stipulate a very definite mode, for instance a user authentication with face ID.

On the basis of the user input, the operating system 126 signs signature data based on the verified process data 148 using the digital signature key 110 in a step 212. To that end, the operating system 126 re-accesses the secure memory 130 of the terminal 106, as indicated by a sub-sequence 158 in FIG. 1B.

In one preferred embodiment, the use of the digital signature key 110 by the operating system 126 is restricted in such a way that it is not possible for arbitrary content to be signed by the app 112. This can help to prevent attacks using a forged signature, which involve signature generation being performed without an output (display) and/or use of the process data that are actually protected. On the basis of the described functionality (display+approval+signature) of the operating system 126, the backend 104 can assume that an available user consent, user authentication, etc., is not forged.

Referring again to FIGS. 1B and 2A, the operating system 126 transmits the signed signature data to the application 112 in a step 214 (this is part of the sequence 146). In a corresponding step 240 (method 230 in FIG. 2B), the app 112 accepts the signed signature data from the operating system 126. In a step 242, the app 112 forwards the signed signature data to the backend 104.

In a corresponding step 270 (method 260 in FIG. 2C), the backend 104 receives the signed signature data from the terminal 106, or the app 112. This ends the sub-sequence or the message exchange 148 for a reliable interaction between the operating system 126 (or the terminal 106) and the backend 104.

In a step 272, the backend 104 verifies the signature data on the basis of the digital signature key 110. In a step 274, the backend transmits an acknowledgement about the performance of the requested process 144 to the terminal 106, or the app 112. In a corresponding step 244 (method 230 in FIG. 2B), the app 112 receives the acknowledgement. This ends the process 142 and the method 140.

From a certain perspective, and with further reference to the illustrative scenarios in FIGS. 1A and 1B, the present disclosure generally proposes providing for standardized signature generation that can then be performed by the device 106, in particular the operating system 126, i.e. independently of an app. This can enable verified information concerning a purpose, a scope, etc., of signature generation to be displayed to the user 108 in a system-specific manner (i.e. natively). In this way, it is possible to make sure that a signature is generated for those data that the user has approved. To put it another way, a compromised app cannot disrupt the process of signature generation; this would require it to crack the generated signature or the signature key 110.

On the basis of the process data transferred with the request by the user 108 or the process data transferred by the app 112, the information about signature generation displayed to the user 108 can be determined and can be received for example by the process-related backend 104 (for example operated by a vehicle manufacturer), by a device manufacturer, a service provider or by third parties. As such, for example a service provider ID can be used to determine a company name, a company address, etc., a service ID or identifier can be used to determine a description of the service, etc.

Based on a TLV standard, the process data can be provided for instance in the form of standardized tags, sub-tags, etc., so that the operating system 126 of the device 106 can process the data and display them to the user (for their consent or rejection), for example in the form of a pop-up window. In one embodiment, there can be provision for a standardized title, for instance, for such a pop-up window, resulting for example from one ID from a plurality of IDs for different specified reasons, or the pop-up window can have an arbitrary title. The pop-up window can have a predefined number of lines of text (e.g. four), each of which consists of a fixed number of characters (e.g. 16), with different colors being able to be supported, text highlighting, different text formats such as italics, bold, etc.

In some preferred embodiments, the pop-up window can have a configuration that is clearly associated with a wallet. This allows it to be made clear to the user that interests worthy of protection are involved. In some of these embodiments, the operating system is configured to prevent pop-up windows with the same or a similar configuration from being displayed (such a pop-up window could be fake).

In these or other embodiments, the pop-up window can comprise an indication (display) of a verified source, or of an origin or a provenance, of the displayed data. By way of example, the indication can comprise an icon on which the user can click to display information about the source.

With further reference to the scenarios of FIG. 1A, 1B, in one embodiment, a vehicle manufacturer, service provider, etc., can pass the backend key 139 (e.g. in the form of a certificate) to the device-based backend 136 so that the key 139 (or the certificate) is pinned there. If the pinned key directly is not used to sign the process or request data, but rather a key derived therefrom, the vehicle manufacturer 104, the service provider 104, etc., must provide a chain of trust (i.e. a chain of intermediate certificates) for the pinned key (or certificate).

In some embodiments, the user 108 uses the app 112 to initiate a request concerning a specific use case, the request containing a signature step (sub-sequence 142). The backend 104 (operated by a vehicle manufacturer, service provider, etc.) that receives the request from the app 112 compiles the necessary request data or process data, signs them and transmits them back to the app 112 (sub-sequence 146).

The app 112 forwards the data to the operating system 126 of the device 106. The operating system 126 verifies the request data: if a known (e.g. standardized) use case is being performed, the operating system 126 can use technical parameters in the request data to determine a user-readable text (e.g. can use a service provider ID to determine a company name and an address of the service provider). If arbitrary data are to be signed, for example according to the CCC, the device 106 or the operating system 126 can use the verified request data to determine a text provided by the vehicle manufacturer, service provider, etc., and thus resolve the applicable request data into text that can be read (by human beings).

The device 106 displays the readable text to the user 108 and asks for consent or approval of the user 108 (which can be delivered by confirming a pop-up window) or an authentication. By way of example, an explicit authentication can be asked for, e.g. using the same method as is also used for unlocking the device 106. Once the user 108 confirms the dialog, the device 106 generates a signature for the or some of the request data. The signature is returned, if necessary together with meta-information, to the app 112 and forwarded by the latter to the backend 104 (this completes the sub-sequence 146 for a reliable interaction between the operating system 126 and the backend 104).

The backend 104 checks or verifies the received signature on the basis of the originally generated request data and, if the verification is positive, performs an action (or multiple actions) defined for the given use case. An illustrative use case relates to a signature for arbitrary data (according to the CCC), wherein arbitrary data provided by a backend or third party are signed. Another use case relates to a service activation request (service management request for a service activation) as defined by the CCC for delegating key sharing rights to a backend authority for a specific purpose (e.g. car sharing).

Other use cases for which methods according to the present disclosure for controlling signature generation on the basis of a digital (signature) key can be used are conceivable. Such use cases do not need to be specified by the CCC and may also be defined only in the future, for example.

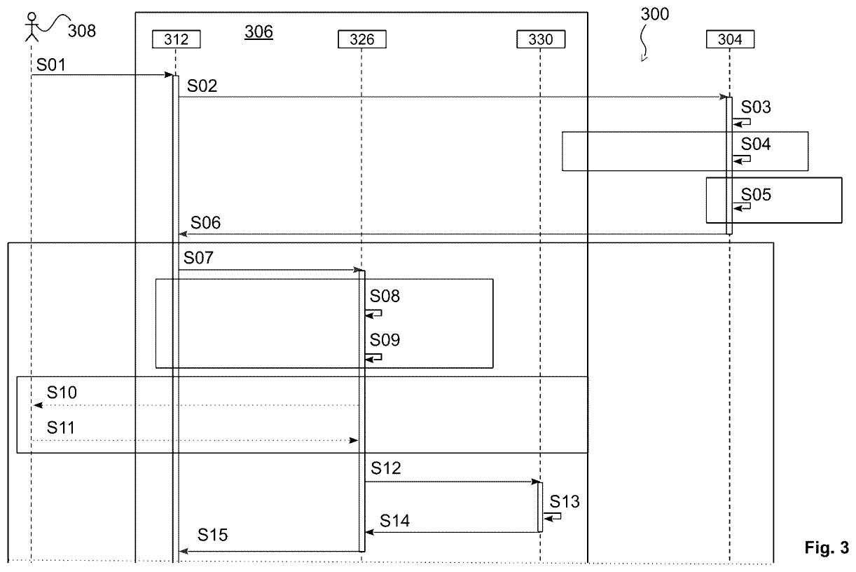

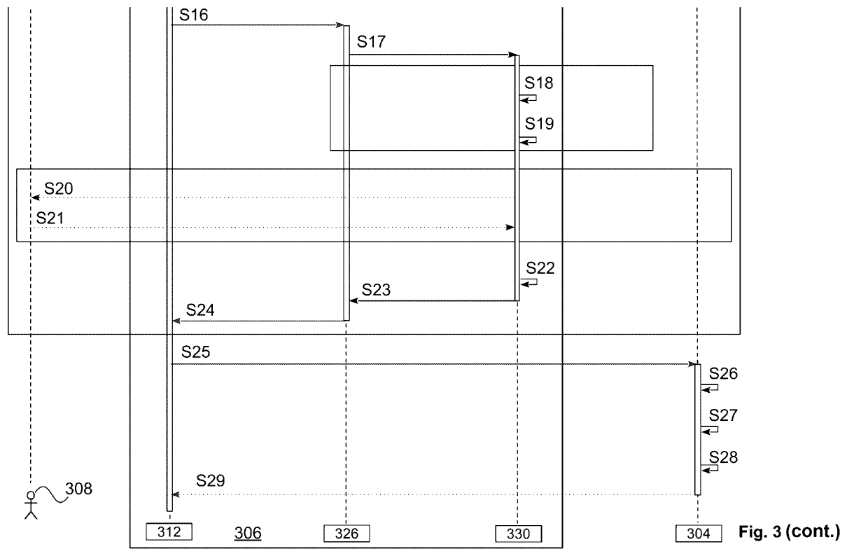

FIG. 3 illustrates another embodiment of a method 300 for controlling signature generation in the form of a schematic flow diagram, the method 300 involving a backend 304 and a terminal 306 of a user 308 cooperating. The terminal 306 has an app 312 installed on it, and the terminal 306 is operated using an operating system 326 and has a secure memory 330. The method 300 can be a specific embodiment of an operating cycle that is in general oriented to the scenarios of FIG. 1A, 1B, and in this respect reference is made to the description of FIG. 1A, 1B for an explanation of details, for instance definitions and terms used, properties of the components, etc. In particular, the terminal 306 with the app 312, the operating system 326 and the secure element 330 can be an embodiment of the terminal 106 with the app 112, the operating system 126 and the secure element 130 from FIG. 1A, 1B, and the backend 304 can be an embodiment of the backend 104 from FIG. 1A, 1B.

The starting point for the method 300 is that a device manufacturer has pinned information available in order to verify data that are displayed to the user 308 during signature generation. The pinned information can be, for instance, a pinned certificate or a cross-signed certificate (for example a certificate of a device manufacturer CA authority that is cross-signed by a vehicle manufacturer).

By way of illustration, the method 300 relates to signature generation for arbitrary data. The use case or process is not known to a device-based backend. The device-based backend 304 (this could also be a backend operated by a service provider or other third parties) compiles arbitrary data and other information that are supposed to be displayed to the user 308 to obtain a user consent (with or without explicit user authentication).

In a step S01, the user 308 uses the app 312 to provide a use case, or performs a corresponding process. In a step S02, the app 312, based on this use case, transmits a request to the process-related backend 304. In a step S03, the backend 304 compiles parameters for this use case. This can include summary information relating to the process or the use case, for example a title, a text, etc.

As regards signing the request data or process data, the backend 304 signs the parameters compiled for the use case in a step S04. A key, or a certificate, that is pinned at a device-based backend is used for signing, or a derived key is used; the latter case requires a chain of trust (i.e. a chain of one intermediate certificate or multiple intermediate certificates). If a chain of certificates is required, the one intermediate certificate or the multiple intermediate certificates are pinned to the signed process parameters in a step S05.

In a step S06, the backend 304 returns the signed process parameters for the requested use case to the app 312, if necessary with the intermediate certificate(s).

In one embodiment (steps S07-S15), in which only approval of the user is supposed to be obtained, the app 312 transmits a request for a signature for arbitrary data with user approval to the operating system 326 of the terminal 306 in a step S07. The request contains the signed process parameters.

First, as regards a verification of the request data, the operating system 326 verifies the signed process parameters against the pinned information in a step S08. To be more precise, a verification of the signature of the signed process parameters can comprise for example a verification of a certificate chain against a pinned certificate or a cross-signed certificate, or cross-certificate. In a step S09, the operating system 326 takes at least some of the user information such as title, text, etc., from the received request. Step S09 can entail components such as a backend for the terminal 306 or other components of the terminal 306 being involved.

As regards a user-related prompt for consent, a request in this regard is output to the user 308 in a step S10. The request displays the taken and verified information (title, text, etc.) to the user 308, together with a prompt for consent or approval. The display can indicate that the information has been verified, for example with a lock symbol that possibly displays source information when clicked on. In a step S11, the user 308 provides an approval.

In a step S12, the operating system 326 then transmits a request for a signature for arbitrary data to the secure memory 330. In a step S13, the secure memory 330 signs the signed process parameters using a digital (signature) key. In a step S14, the secure memory 330 returns the signature; this can be in particular a SIGN data structure (SIGN response) comprising SIGN data fields according to the CCC.

In a step S15, the operating system 326 returns the signature, including the SIGN data structure and SIGN data fields, to the app 312.

In another embodiment (steps S16-S24), which is an alternative to the embodiment comprising steps S07-S15, an authentication of the user 308 is requested. To that end, the app 312 transmits a request for a signature for arbitrary data with user authentication to the operating system 326 in a step S16. The request contains the signed process parameters. In a step S17, the operating system 326 forwards the request to the secure memory 330.

First, as regards a verification of the request data, the secure memory 330 verifies the signed process parameters against pinned information in a step S18. To be more precise, a verification of the signature of the signed process parameters can comprise for example a verification of a certificate chain against a pinned certificate or a cross-signed certificate. In a step S19, the secure memory 330 takes at least some of the user information such as title, text, etc., from the received request. Step S19 can entail components such as a backend for the terminal 306 or other components of the terminal 306 being involved.

As regards a user-related display of the verified information and a user-related prompt for consent, a request in this regard is output to the user 308 in a step S20. The request displays the taken and verified information (title, text, etc.) to the user 308, together with a prompt for authentication. The display can indicate that the information has been verified, for example with a lock symbol that possibly displays source information when clicked on.

In a step S21, the user 308 provides a user authentication. The secure memory 330 then signs the signed process parameters using a digital signature key in a step S22. In a step S23, the secure memory 330 returns the signature to the operating system 326; this can be in particular a SIGN data structure (SIGN response) comprising SIGN data fields according to the CCC. In a step S24, the operating system 326 returns the signature, including the SIGN data structure and SIGN data fields, to the app 312.

Irrespective of whether the embodiment comprising steps S07-S15 or the embodiment comprising steps S16-S24 has been implemented, the app 312 forwards the signature, including the SIGN data structure and SIGN data fields, to the backend 304 in a step S25. In a step S26, the backend 304 verifies the received request in general (check on a session ID, etc.). In a step S27, the backend 304 verifies the received signature, including the SIGN data structure and SIGN data fields, against the signed process data. In a step S28, the process-related backend 304 performs an action linked to the process or use case. In a step S29, the backend 304 returns a success message to the app 312.

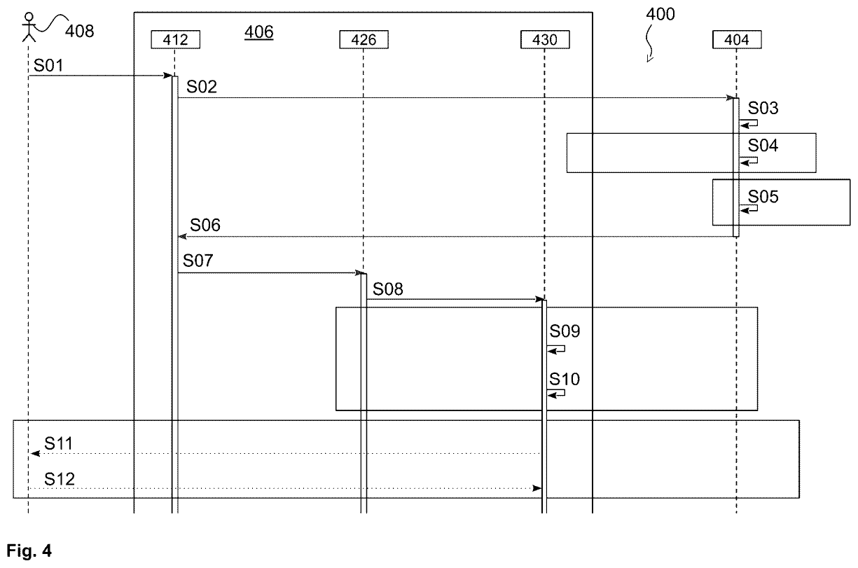

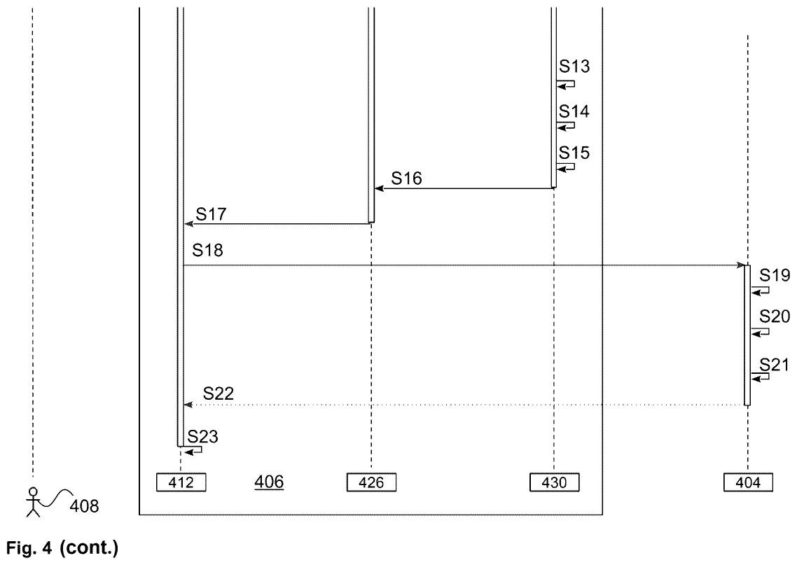

FIG. 4 illustrates another embodiment of a method 400 for controlling signature generation in the form of a schematic flow diagram, the method 400 involving a backend 404 and a terminal 406 of a user 408 cooperating. The terminal 406 has an app 412 installed on it, and the terminal is operated using an operating system 426 and has a secure memory 430. The method 400 can be a specific embodiment of an operating cycle that is in general oriented to the scenarios of FIG. 1A, 1B, and in this respect reference is made to the description of FIG. 1A, 1B for an explanation of details, for instance definitions and terms used, properties of the components, etc. In particular, the terminal 406 with the app 412, the operating system 426 and the secure element 430 can be an embodiment of the terminal 106 with the app 112, the operating system 126 and the secure element 130 from FIG. 1A, 1B, and the backend 404 can be an embodiment of the backend 104 from FIG. 1A, 1B.

The starting point for the method 400 is a use case relating to a service activation that is used to grant the backend 404 key sharing rights within a certain, service-specific scope. The use case is known to a device manufacturer, and so a device-based backup can look for data that are supposed to be displayed to the user 404.

It is assumed that the backend 404 is a vehicle-related backend, although the backend can generally also be operated by a service provider or other third party.

In a step S01, the user 408 uses the app 412 to provide a service activation. In a step S02, the app 412 transmits a request relating to a service activation to the vehicle-based backend 404. The request includes a service ID, parameters, etc. In a step S03, the backend 404 compiles parameters for this use case. This can include information relating to a service provider (service provider ID) and optionally a particular service (service ID) that is supposed to be activated. A service activation is specified as the action to be performed. Parameters are set, or selected.

As regards signing the request data, the backend 404 signs the parameters compiled for the process in a step S04. A key, or a certificate, that is pinned at a device-based backend is used for signing, or a derived key is used; this requires a chain of trust (a chain of one intermediate certificate or multiple intermediate certificates). If a chain of certificates is required, the one intermediate certificate or the multiple intermediate certificates are pinned to the signed process parameters in a step S05.

In a step S06, the backend 404 returns the signed process parameters for the requested use case to the app 412, if necessary with the intermediate certificate(s). In a step S07, the app 412 transmits a request to sign a service management request to the operating system 426. The request contains the signed process parameters and if necessary the intermediate certificate(s). In a step S08, the operating system 426 forwards the request to the secure memory 430.

First, as regards a verification of the request data and a determination of user-relevant information, the secure memory 430 verifies the signed process parameters against the pinned information in a step S09. To be more precise, a verification of the signature of the signed process parameters can comprise for example a verification of a certificate chain against a pinned certificate or a cross-signed certificate. In a step S10, the secure memory 430 determines the following information: information relating to a service provider (for example a service provider ID according to secure-sign data as specified by the CCC) and information relating to the service (for example service ID).

As regards a user display of the verified information and a user-related prompt for consent, a request in this regard is output to the user 408 in a step S11. The request displays the service provider and the service-related information to the user 408, for example in the form service provider name, address, service description, together with a prompt for authentication. The display can indicate that the information has been verified, for example with a lock symbol that possibly displays source information when clicked on.

In a step S12, the user 408 provides a user authentication. In a step S13, the secure memory 430 compiles service management request data (according to the CCC) that comprise the signed secure-sign data.

In a step S14, the secure memory 430 signs the compiled data using a digital signature key. In a step S15, the secure memory 430 compiles a service management request from the service management request data and the signature.

In a step S16, the secure memory 430 returns the service management request to the operating system 426. In a step S17, the operating system 426 returns the service management request to the app 412. In a step S18, the app 412 forwards the service management request to the backend 404.

In a step S19, the backend verifies the general request (check on the session ID, etc.). In a step S20, the backend 404 verifies the received request in general (check on a session ID, etc.). In a step S21, the backend 404 stores a process token; this sets a status to “Active”. Key sharing or forwarding for the given token is accepted from now on. In a step S22, the backend 404 returns a success message to the app 412. In a step S23, the app displays the service status “Active”, and details of the service, etc.

As described, processes for which there is provision for a form of user consent (with or without authentication) on a terminal have hitherto had a security issue because a compromised app can display to a user information about a process or an action that does not correspond to a process that is actually performed or to an action that is actually performed. The present disclosure proposes that an operating system of the terminal encapsulates a display to the user, their confirmation (approval, consent, etc., with/without authentication), and a subsequently generated signature for the process in a secure function, or a secure functionality. This allows safety, or safeguarding, of a user confirmation for a given process to be raised from a level of an application to an operating system level.

In order for an operating system of the terminal to be able to process the process data received from a process-related backend and prepare user information, a standardization of an appropriate message exchange is proposed.

The operating system can use a trust anchor to verify that the received process data actually originate from the process-related backend. This can be guaranteed for example as a result of a key managed in the process-related backend being considered reliable in a device-based backend, for example by a certificate chain, pinning of a certificate in the device-based backend, etc.

The operating system thus uses two keys for the process of signature generation, a key based on the trust anchor and a signature key (in the case of asymmetric cryptography: two key pairs). Both keys are stored in secure form in the terminal, for example in a secure memory, and so access to the keys is limited and is possible for example only by the operating system, but not by the process-related app.

It is therefore possible for an operating cycle of a process, performance of an action, etc., to be guaranteed end to end from a request to performance, i.e. the user can be confident that the displayed and confirmed process is the one that is also actually performed. A compromised app cannot intervene in or disrupt signature generation, since this would result in a signature being invalid (i.e. not being able to be verified), or would require a successful attack on one of the cryptographic keys used.

Embodiments of the present disclosure are of commercial interest to vehicle manufacturers, device manufacturers, car sharing providers, third-party providers of services such as breakdown assistance, parking service, etc.

The foregoing disclosure has been set forth merely to illustrate the present disclosure and is not intended to be limiting. Since modifications of the disclosed embodiments incorporating the spirit and substance of the present disclosure may occur to persons skilled in the art, the present disclosure should be construed to include everything within the scope of the appended claims and equivalents thereof.

### REFERENCE SIGNS

100 system
102 motor vehicle, vehicle
104 backend
106 terminal, mobile device, device
108 user
110 digital vehicle key
112 application, app
114 use case, process
116 message containing user information
118 user output
120 user input
122 acknowledgement
124 message exchange according to the present disclosure, message sequence
126 operating system
128 user output
130 secure memory
132 user interface, HMI
134 database, LUT
136 backend for the terminal
138 trust anchor
139 backend key
140 method for signature generation
142 sub-sequence between backend and app (process-related)
144 requested process
146 sub-sequence between backend and app (signature generation)
148 signed process data
150 sub-sequence between operating system and secure memory (trust anchor)
152 sub-sequence between operating system and device-based backend
156 sub-sequence between operating system and HMI
158 sub-sequence between operating system and secure memory (signature key)
200 method in the operating system
202 receive signed process data
204 verify the signed process data
206 generate user information
208 output user information
210 accept a user input
212 signed signature data
214 transmit the signature data
230 method in the app
232 user input
234 transmit a request
236 receive process data
238 forward the process data
240 accept signature data
242 forward the signature data
244 receive an acknowledgement
260 method in the backend
262 receive a request
264 compile process data
266 sign the process data
268 transmit the process data
270 receive signature data
272 verify the signature data
274 transmit an acknowledgement
300 system
304 backend
306 terminal, mobile device, device
308 user
312 app
326 operating system
330 secure memory
400 system
404 backend
406 terminal, mobile device, device
408 user
412 app
426 operating system
430 secure memory

What is claimed is:

1. A method for controlling signature generation in a terminal, comprising:
receiving signed process data and verifying the received signed process data on the basis of a trust anchor, the trust anchor being stored in a secure memory of the terminal;
outputting user information based on the verified process data on a user interface of the terminal;
accepting a user input;
on the basis of the user input, signing signature data based on the verified process data using a digital signature key, the digital signature key being stored in the secure memory of the terminal; and
transmitting the signed signature data.

2. The method according to claim 1, wherein the process data is received in a standardized format.

3. The method according to claim 1, wherein at least one from the following is controlled by an operating system of the terminal:
the verification of the received process data;
the output of the user information;
the acceptance of the user input;
the signing of the signature data.

4. The method according to claim 1, also comprising:
generating the user information, comprising at least one from the following:
extracting user information from the received process data;
requesting user information from a device-based backend on the basis of the process data;
determining a standardized process on the basis of the process data and providing user information for the determined standardized process.

5. The method according to claim 1, also comprising:
receiving an indication of a user authentication mode; and
controlling the terminal to accept the user input according to the indication.

6. The method according to claim 1, wherein the trust anchor relates to a directly exchanged or cross-signed certificate that applies to a backend key in a process-related backend at least by a chain of trust.

7. The method according to claim 1, wherein the digital signature key comprises one from the following:
a digital vehicle key;
a cryptographic key of a CA authority of the terminal;
a cryptographic signature key of the secure memory;
a cryptographic key that is supported by the operating system.

8. A method for controlling signature generation in an application for a terminal, comprising:
receiving signed process data from a process-related backend;
forwarding the signed process data to an operating system of the terminal to control a user input concerning the signature generation;
accepting signed signature data from the operating system; and
forwarding the signed signature data to the backend.

9. The method according to claim 8, also comprising:
receiving an upstream user input and transmitting a request to perform a process on the basis of the upstream user input;
receiving a downstream acknowledgement relating to performance of the requested process.

10. A method for controlling signature generation in a process-related backend, comprising:
receiving a request to perform a process from a terminal;
compiling process data concerning the requested process;
signing the compiled process data using a digital backend key managed by the backend; and
transmitting the signed process data to the terminal.

11. The method according to claim 10, also comprising:
receiving signed signature data relating to the requested process from the terminal;
verifying the signature data on the basis of a digital signature key; and
transmitting an acknowledgement relating to performance of the requested process to the terminal.

12. The method according to claim 10, wherein the process relates to one from the following:
a service management request standardized according to the Car Connectivity Consortium;
signature generation for arbitrary data, standardized according to the Car Connectivity Consortium.

13. A computer program product comprising program code sections for carrying out the method according to claim 1 when the computer program product is executed on a computer, the computer program product relating to an operating system of a terminal.

14. A computer program product comprising program code sections for carrying out the method according to claim 8 when the computer program product is executed on a computer, the computer program product relating to an application for a terminal.

15. A terminal configured to carry out a method for controlling signature generation, comprising:
a secure memory for storing a trust anchor and a digital signature key;
the operating system according to claim 13; and
an application comprising program code sections for carrying out a method when the application is executed on a computer, the method comprising:
receiving signed process data from a process-related backend;
forwarding the signed process data to the operating system to control a user input concerning the signature generation;
accepting signed signature data from the operating system; and
forwarding the signed signature data to the backend.

16. A backend server configured to carry out a method for controlling signature generation according to claim 10.

17. A system configured to perform a process in a manner guaranteed by signature generation, the system comprising:
the terminal according to claim 15; and
the backend server configured to carry out a method for controlling signature generation, the method comprising:
receiving a request to perform a process from the terminal;
compiling process data concerning the requested process;
signing the compiled process data using a digital backend key managed by the backend; and
transmitting the signed process data to the terminal.
